(19) United States
(12) Patent Application Publication
(10) Pub. No.: US 2025/0333305 A1
(43) Pub. Date: Oct. 30, 2025

(54) SULFUR GAS RECOVERY INCINERATOR INTELLIGENT FUEL OPTIMIZER

(71) Applicant: SAUDI ARABIAN OIL COMPANY, Dhahran (SA)

(72) Inventors: Mohammed Rashed Aldossary, Dhahran (SA); Dedik Rahmat Ermawan, Jubail (SA)

(73) Assignee: SAUDI ARABIAN OIL COMPANY, Dhahran (SA)

(21) Appl. No.: 18/651,447

(22) Filed: Apr. 30, 2024

(51) Int. Cl. C01B 17/04; B01D 53/34; B01D 53/48

(52) U.S. Cl. CPC C01B 17/0417; B01D 53/346; B01D 53/48; B01D 2257/30; B01D 2258/0283

(57) ABSTRACT

Systems and methods for minimizing fuel consumption in an incinerator system in a sulfur recovery unit (SRU), including obtaining input gas flow data for streams entering the incinerator system of the SRU. Systems and methods also include making a determination of whether the SRU is operated with a tail gas treatment unit (TGTU), selecting a first relationship in response to the determination that the SRU is not operated with the TGTU and otherwise selecting a second relationship. Systems and methods further include determining an optimal incinerator system temperature based on the input gas flow data and using the first or the second relationship, determining, based on the optimal incinerator system temperature, an optimal flow rate of a fuel gas used in the incinerator system, and adjusting a fuel gas flow rate to the optimal flow rate of the fuel gas.

### BACKGROUND

Industrial plants, such as natural gas processing plants, generally operate to produce “clean” natural gas by separating impurities from raw natural gas using one or more unit operations. The unit operations include mainly separators, which may require large amounts of fuel to provide the energy needed for the separation process. Consequently, large costs are associated with supplying the large amounts of fuel, often in the form of fuel gas, to said unit operations. Improving efficiency of fuel gas utilization may therefore reduce the cost of plant operations. In addition, managing fuel gas utilization may help improve reduce carbon footprint, thus promoting environmentally friendly operations.

Sulfur recovery is a known process in natural gas processing. Sulfur is a naturally occurring element in oil and gas formations, however, sulfur compounds are often toxic and therefore must be removed from refined gas. A sulfur recovery unit (SRU) includes processes and unit operations to remove sulfur containing products, such as hydrogen sulfide (H₂S) gas from a natural gas stream. For hydrocarbon streams to be useful and safe for subsequent energy generation and production, acid gases must be reduced to an acceptable level. For example, 5-15 ppm of H₂S is generally acceptable for natural gas, but the accepted range varies between countries. The process of removing acidic sulfuric compounds (primarily H₂S) is known as “sweetening.”

A conventional example of the sweetening process uses an amine-based scrubbing process to strip H₂S and CO₂ from natural gas. The H₂S-rich stream then goes into an SRU to produce solid sulfur by undergoing a high-temperature (ca. 1000° C.) thermal oxidation and a subsequent catalytic oxidation (ca. 200-300° C.). SRU Incinerators are conventionally operated by maintaining a fixed target temperature regardless of the amount of burned tail gas. Due to high-temperature operational conditions, the amine-based scrubbing process combined with a SRU is energy-intensive, inefficient, and contributes to a significant portion of a site's carbon footprint.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for minimizing fuel consumption in an incinerator system in a sulfur recovery unit (SRU), including the incinerator system having a temperature control system, where at least a fuel gas, a claus tail gas, and a combined process gas enter the incinerator system. The system also includes a claus tail gas line having a claus tail gas flow control system configured to measure a claus tail gas stream flow rate, where the claus tail gas flows through the claus tail gas line, a combined process gas line having a process gas flow control system configured to measure a process gas stream flow rate, where the combined process gas flows through the combined process gas line, and a fuel gas line having a fuel flow control system configured to measure a fuel gas flow rate, where the fuel gas flows through the fuel gas line. The system further includes a controller, communicably coupled to the fuel flow control system disposed on the fuel gas line to control the fuel gas flow rate, and the temperature control system in the incinerator system to control an incinerator system temperature. The controller is configured to obtain input gas flow data, the input gas flow data including the process gas stream flow rate and the claus tail gas stream flow rate, make a determination of whether the SRU is operated with a TGTU, select a first relationship in response to the determination that the SRU is not operated with the TGTU and otherwise selecting a second relationship. The controller is further configured to determine, with the selected relationship of the first relationship and the second relationship, an optimal incinerator system temperature based on the input gas flow data, determine, based on the optimal incinerator system temperature, an optimal flow rate of the fuel gas, and adjust, with the controller, the fuel gas flow rate to the optimal flow rate of the fuel gas.

In another aspect, embodiments disclosed herein relate to a method for minimizing fuel consumption in an incinerator system in a sulfur recovery unit (SRU), including obtaining input gas flow data, where the input gas flow data includes a process gas stream flow rate, for a combined process gas stream and a claus tail gas flow rate for a claus tail gas stream that enter the incinerator system of the SRU. The method also includes making a determination of whether the SRU is operated with a TGTU, selecting a first relationship in response to the determination that the SRU is not operated with the TGTU and otherwise selecting a second relationship. The method further includes determining, with the selected relationship of the first relationship and the second relationship, an optimal incinerator system temperature based on the input gas flow data, determining, based on the optimal incinerator system temperature, an optimal flow rate of a fuel gas used in the incinerator system, and adjusting, with a controller, a fuel gas flow rate to the optimal flow rate of the fuel gas.

In yet another aspect, embodiments disclosed herein relate to a non-transitory computer-readable memory having computer-executable instructions stored thereon that, when executed on a processor, cause the processor to perform steps including obtaining input gas flow data, where the input gas flow data includes a process gas stream flow rate for a combined process gas stream and a claus tail gas flow rate for a claus tail gas stream that enter an incinerator system of a sulfur recovery unit (SRU). The steps also include making a determination of whether the SRU is operated with a tail gas treatment unit (TGTU), selecting a first relationship in response to the determination that the SRU is not operated with the TGTU and otherwise selecting a second relationship. The steps further include determining, with the selected relationship of the first relationship and the second relationship, an optimal incinerator system temperature based on the input gas flow data, determining, based on the optimal incinerator system temperature, an optimal flow rate of a fuel gas used in the incinerator system, and adjusting a fuel gas flow rate to the optimal flow rate of the fuel gas.

Other aspects and advantages of the claimed subject matter will be apparent from the following description and the appended claims.

### BRIEF DESCRIPTION OF DRAWINGS

FIG. 1 depicts an example sulfur recovery unit.

FIG. 2A shows an example system where a tail gas treatment unit is offline, according to one or more embodiments.

FIG. 2B shows an example system where a tail gas treatment unit is online, according to one or more embodiments.

FIG. 3 is a flow chart for a method according to one or more embodiments.

FIG. 4 is a flow chart for a simulation method according to one or more embodiments.

FIG. 5 depicts a flow chart in accordance with one or more embodiments.

FIG. 6 is a computer system according to one or more embodiments.

FIG. 7 illustrates a chart of a first relationship according to one or more embodiments.

FIG. 8 illustrates a chart of a second relationship according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “valve” may include any number of “valves” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

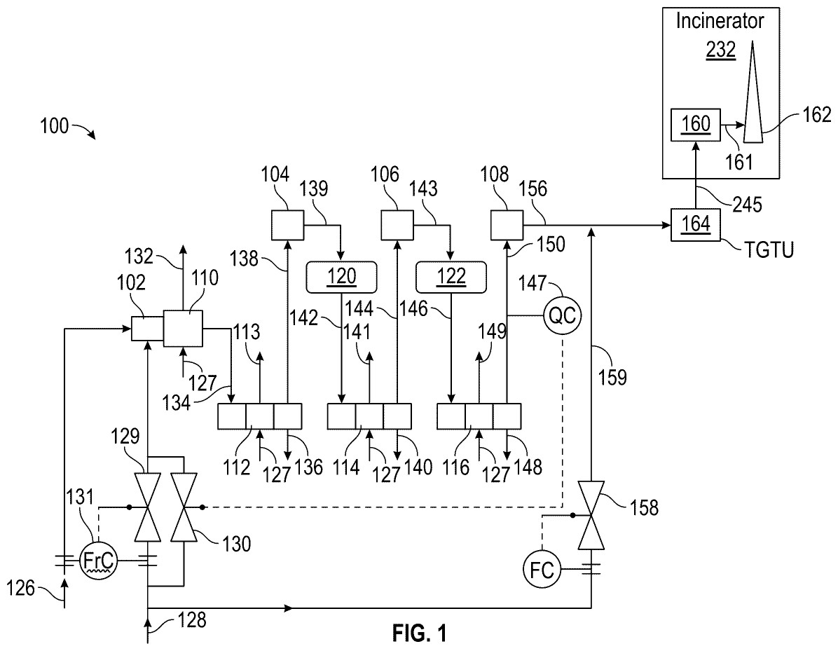

In the following description of FIGS. 1-8, any component described with regard to a figure, in various embodiments disclosed herein, may be equivalent to one or more like-named components described with regard to any other figure. For brevity, descriptions of these components will not be repeated with regard to cach figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein generally relate to systems and methods to automatically adjust the operation of a sulfur recovery unit (SRU) using an SRU Fuel Optimizer. The SRU fuel optimizer according to one or more embodiments may receive flow rate data from one or more flow control systems, process the received data, determine an optimal incinerator system temperature using an empirical relationship between the flow rate and the incinerator system temperature, and adjust the incinerator system temperature to the optimal incinerator system temperature.

Generally, an SRU receives Hydrogen Sulfide (H₂S) as part of a gas feedstock and converts the H₂S to elemental sulfur through the Claus reaction. FIG. 1 illustrates a diagram of an example SRU 100. Typically, the primary equipment used in a SRU 100 include a reaction furnace burner 102, multiple re-heaters 104, 106, and 108, which are typically shell and tube exchangers, a waste heat boiler 110, sulfur condensers 112, 114, and 116, catalyzing Claus converters 120 and 122, heat exchangers, and fluid delivery pipes. The first stage re-heater 104 may also be an auxiliary burner. An acid gas feed 126, received via an inlet, is pre-heated, if required, depending on the H₂S concentration in the feed gas. The pre-heating is performed using a fired heater or a shell and tube exchanger in order to achieve the required minimum reaction furnace temperature. The pre-heated acid gas is then sent to the reaction furnace burner 102 where H₂S undergoes combustion in the presence of oxygen in the combustion air 128, or oxidation air feedstock, received via an oxidation air inlet. The combustion air 128 is also pre-heated using a fired heater (or a combination of fired heater and shell and tube exchanger) prior to admitting to reaction furnace. The combustion air is controlled by valves 129, 130, which may be flow control valves (FCVs). A flow ratio control (FrC) valve 131 may control the stochiometric ratio for combustion based on the flow rate of the acid gas feed 126. In one or more embodiments, one of the valves is a trim air flow control valve 130 and the other is a main air flow control valve 129.

Referring to FIG. 1, the process gas 134 which is fed to the first stage sulfur condenser 112, is produced in the reaction furnace burner 102 where the acid gas feed 126 H₂S mixes proportionally with the combustion air 128. The temperature of the process gas 134 in the reaction furnace burner 102 may be in the range of 1900-2200° F. In instances where ammonia is present in the acid gas feed, the temperature of the process gas 134 in the reaction furnace burner 102 may be over 2300° F. for destruction. Boiler feed water (BFW) 127 may be introduced in the waste heat boiler 110 (or steam drum) thereby cooling the process gas 134 to a temperature in the range of 600-650° F. and producing a high/medium pressure steam 132. Depending on the SRU configuration and BFW 127 pressure, high/medium pressure steam 132 may be generated using the waste heat boiler 110.

Once the process gas 134 is cooled to, for example, to a temperature of 175-180° C. (350-360° F.) in the first stage sulfur condenser 112, a first liquid sulfur 136 may be condensed, separated, and flow to a sulfur pool, and a first low-pressure (LP) steam 113 may be produced. A first non-condensed process gas 138 may be produced from the first stage sulfur condenser 112. The remaining mixture of H₂S and sulfur dioxide (SO₂) in the first non-condensed process gas 138 may be fed to a Claus reaction system to form additional elemental sulfur. The gases may be heated to approximately 210-220° C. (410-430° F.). Once equilibrium conditions are reached, the elemental sulfur is removed before the gases are passed to the following reactor stage. The elemental liquid sulfur is removed via stages of condensation with the sulfur condensers 112, 114, and 116 followed by catalytic reactions via the catalyzing Claus converters 120 and 122 to increase sulfur recovery rates, as described below.

In some instances, the first non-condensed process gas 138 from the first stage sulfur condenser 112 is heated to about 210-220° C. (410-430° F.) in a first stage re-heater 104, producing a first heated process gas stream 139. The first heated process gas stream 139 may then be sent to a first Claus converter 120, where the H₂S in the first heated process gas stream 139 may be converted to elemental sulfur, producing a second process gas stream 142. BFW 127 may be introduced in the second stage sulfur condenser 114, thereby cooling the second process gas stream 142 to about 175° C. (350° F.). A second liquid sulfur 140 may be condensed, separated, and flow to the sulfur pool, producing a second low-pressure (LP) steam 141.

A second non-condensed process gas 144 from the second stage sulfur condenser 114 may be re-heated to approximately 210-220° C. (410-430° F.) in a second stage re-heater 106, producing a second heated process gas stream 143. The second heated process gas stream 143 may then be sent to a second Claus converter 122. The H₂S in the second heated process gas stream 143 may be converted to elemental sulfur, producing a third process gas stream 146. The third process gas stream 146 may be cooled to about 150° C. (300° F.) in a third stage sulfur condenser 116. A third liquid sulfur 148 may be condensed, separated, and flow to the sulfur pool, producing a third low-pressure (LP) steam 149. A QC (quality control) analyzer 147 may function to increase the air/oxygen based on H₂S content downstream of the third stage sulfur condenser 116. In one or more embodiments, the QC analyzer 147 is an online tail gas analyzer. The QC analyzer 147 functions to maintain H₂S concentration at approximately a H₂S:SO₂ ratio of 2:1 during. The QC analyzer 147 adjusts combustion air (oxygen) based on a feedback signal. The Claus process, as described, is controlled by controlling the ratio of the oxygen (in the combustion air 128) and the H₂S (in the acid gas feed 126). Sulfur recovery depends on the ratio of H₂S and SO₂ being approximately 2:1 for the Claus reaction. To obtain this ratio, the air control in the SRU needs to be operated with high efficiency.

A third non-condensed process gas 150 from the third stage sulfur condenser 116 may be heated to about 210-220° C. in a third stage re-heater 108, producing a claus tail gas 156.

Any remaining sulfur containing compounds in the tail gas 156 may be sent to an incinerator 160, such as a thermal oxidizer incinerator. The incinerator 160 may burn the remaining sulfur containing compounds in the presence of excess oxygen. Stack gas 161 may then be fed to a thermal oxidizer stack 162 for dispersion to the environment.

An incinerator system 232 according to one or more embodiments may include the incinerator 160 and a thermal oxidizer stack 162. The incinerator system 232 may receive a claus tail gas 156 as shown in FIG. 1, as one input to the incinerator system 232 when a tail gas treatment unit (TGTU) 164 is offline. When the TGTU 164 is online, the incinerator system 232 may receive a TGTU offgas stream 244. According to one or more embodiments, the TGTU is in-line with the SRU as shown in FIG. 1. Thus, when the TGTU 164 is online, the claus tail gas 156 enters the TGTU 164 and is further treated, producing a TGTU offgas stream 244. The TGTU offgas stream 244 then enters the incinerator system 232. When the TGTU 164 is offline, it may be envisioned that the claus tail gas 156 essentially bypasses the TGTU 164 and enters directly into the incinerator system 232.

Incinerator systems may be significant consumers of fuel gas, accounting for a major portion of a plant's fuel usage. Systems and methods according to one or more embodiments minimize the fuel gas consumption by calculating a precise amount of fuel gas required to convert H₂S into SO₂, for example, in a Sulphur Recovery Unit (SRU) incinerator. In the literature, an SRU may referred to as a “Claus unit.” This is because the SRU is commonly based on a Claus process (or modified Claus process). For consistency, only the term “SRU” is used herein as opposed to the term “Claus unit,” however, one with ordinary skill in the art will recognize that this choice of nomenclature does not impose a limitation on the instant disclosure. SRUs and are often used in natural gas processing operations to convert toxic H₂S into SO₂. Conventionally, an SRU, and in particular the incinerator system 232, is configured to maintain a constant temperature through a constant fuel gas consumption regardless of the acid feed gas. In contrast, embodiments disclosed herein relate to methods and systems to dynamically adjust a fuel gas consumption based on real-time requirements, leading to substantial fuel savings.

A gas treatment plant may include both a primary SRU incineration process and a Tail Gas Treatment process to further treat gas streams resulting from the primary SRU. In accordance with one or more embodiments, a gas treatment plant may operate according to two distinct operational modes. The first mode addresses the operation of an SRU without inclusion of a Tail Gas Treatment Unit (TGTU), while the second accommodates the integration of the SRU with a TGTU. Regardless of whether the plant operates with or without the TGTU, methods according to embodiments disclosed herein may provide significant fuel gas savings across both scenarios by implementing methods which adjust the incinerator temperature using automatic logic. Embodiments disclosed herein not only optimize fuel gas consumption but may also eliminate the need for constant fuel gas usage, irrespective of train load. The implementation of automatic logic according to methods disclosed herein may allow the incinerator to autonomously (i.e., without the need of human interference) reduce fuel gas usage in response to decreases in feed gas, thereby minimizing human intervention and enhancing operation efficiency. As will be discussed in more detail in the following sections, the method automatically adjusts incinerator temperature based on an inlet gas flowrate, using separate correlations between optimum incinerator temperature when the TGTU is online and when the TGTU is offline.

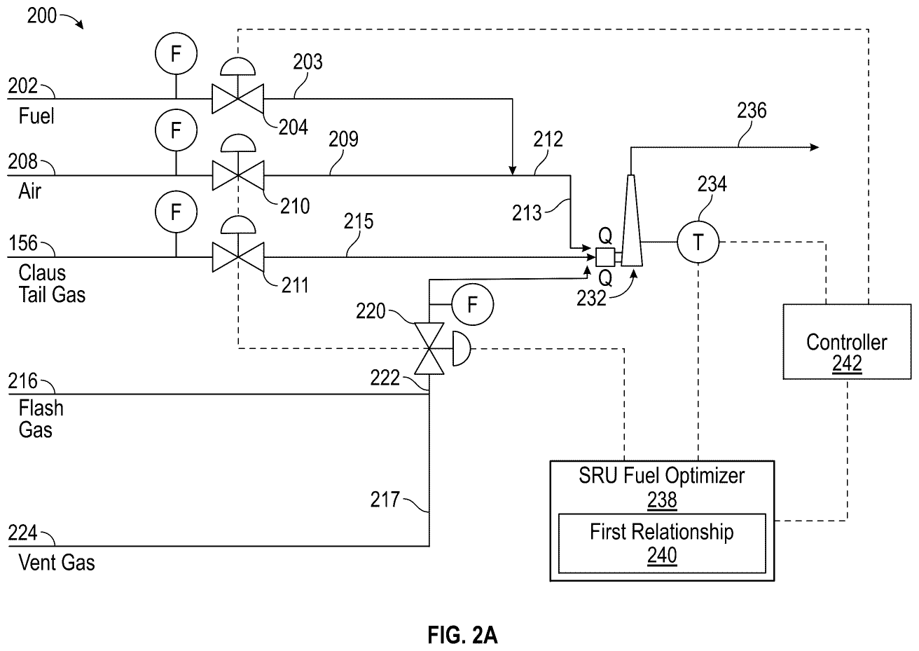

FIGS. 2A and 2B illustrate systems for implementing an SRU fuel optimizer in accordance with one or more embodiments. The SRU fuel optimizer optimizes incinerator fuel gas consumption using a described automatic logic that accounts for two scenario cases, namely, a first case where the tail gas treatment unit (TGTU) is offline (FIG. 2A) and a second case where the TGTU is online (FIG. 2B).

FIG. 2A shows a first system 200 for implementing an SRU fuel optimizer where a TGTU is offline, according to one or more embodiments. The first system 200 may include a fuel gas stream 202, an air stream 208, a claus tail gas stream 156, a flash gas stream 216, and a vent gas stream 224. The fuel gas stream 202 may pass through a fuel gas line 203, where the fuel gas line 203 includes a fuel flow control system 204.

The fuel gas stream of one or more embodiments may include primarily a fuel, such as light hydrocarbons (i.e., hydrocarbons having a carbon count of between 1 and about 4, “C₁₋₄”), and nitrogen (N₂) gas. The fuel gas stream may include moderate amounts of other components, including but not limited to water vapor and carbon dioxide (CO₂). The fuel gas stream may also include minor amounts of other components, such as hydrogen sulfide (H₂S), benzene, toluene, p-xylene, helium, and medium and heavier hydrocarbons.

In one or more embodiments, the fuel may be a low British Thermal Units (BTU) fuel or a high BTU fuel.

In one or more embodiments, the fuel gas stream may be comprised of the fuel in a concentration having a range of from about 40 mol % to about 70 mol %. In one or more embodiments, the fuel gas stream may have a fuel concentration in a range having a lower limit of any one of 40, 45, and 50 mol %, and an upper limit of any of 55, 60, and 70 mol %, where any lower limit may be used in combination with any mathematically-compatible upper limit.

In one or more embodiments, the fuel gas stream may be comprised of N₂ in a concentration having a range of from about 15 mol % to about 45 mol %. In one or more embodiments, the fuel gas stream may have an N₂ concentration in a range having a lower limit of any one of 15, 20, and 25 mol %, and an upper limit of any of 30, 40, and 45 mol %, where any lower limit may be used in combination with any mathematically-compatible upper limit.

The fuel flow control system of one or more embodiments may include several components including but not limited to a flow control device and a flow meter. The flow control device may be a choke valve, orifice, needle valve, or the like. A flow meter is connected to the flow control mechanism to measure a flow rate through the fuel gas line. The flow meter may be any flow meter known in the art capable of measuring a fluid flow rate. The flow meter of one or more embodiments may be an ultrasonic flow meter, a vortex flow meter, a magnetic flow meter, a turbine flow meter, a paddle wheel flow meter, and the like.

Returning to FIG. 2A, the air stream 208 may pass through an air line 209, where the air line 209 includes an air flow control system 210. The air stream 208 may combine with the fuel gas stream 202 to produce a fuel inlet stream 212. The fuel inlet stream 212 may pass through a fuel inlet line 213 and enter an incinerator system 232.

The air stream of one or more embodiments may have any composition associated with atmospheric gases. As a non-limiting example, the air intake stream may include a majority of 78% nitrogen (N₂) gas and about 21% oxygen (O₂) gas. As would be understood by one of ordinary skill in the art, the air intake stream may also include small amounts of particulate matter and other gases, including by not limited to carbon dioxide, argon, and water vapor.

The air flow control system of one or more embodiments may include several components including but not limited to a flow control device and a flow meter. The flow control device may be a choke valve, orifice, needle valve, or the like. A flow meter is connected to the flow control mechanism to measure a flow rate through the air line. The flow meter may be any flow meter known in the art capable of measuring a fluid flow rate. The flow meter of one or more embodiments may be an ultrasonic flow meter, a vortex flow meter, a magnetic flow meter, a turbine flow meter, a paddle wheel flow meter, and the like.

The fuel inlet stream of one or more embodiments may include any of the combined components of the fuel gas stream and the air gas stream from which it originates.

The claus tail gas stream 156 may pass through a claus tail gas line 215, where the claus tail gas line 215 includes a claus tail gas flow control system 211. The claus tail gas stream 156 may originate from a Sulfur Recovery Unit (SRU), such as the Example SRU depicted in FIG. 1.

The claus tail gas stream may include primarily CO₂ and N₂. The claus tail gas stream may also contain moderate amounts of H₂ and water vapor. The claus tail gas may contain minor amounts of other components, such as Ar, H₂S, and other sulfur containing components.

In one or more embodiments, the claus tail gas stream may be comprised of the CO₂ in a concentration having a range of from about 50 mol % to about 75 mol %. In one or more embodiments, the claus tail gas stream may have a CO₂ concentration in a range having a lower limit of any one of 50, 55, and 60 mol % and an upper limit of any of one of 70 and 75 mol %, where any lower limit may be used in combination with any mathematically-compatible upper limit.

In one or more embodiments, the claus tail gas stream may be comprised of the N₂ in a concentration having a range of from about 15 mol % to about 30 mol %. In one or more embodiments, the claus tail gas stream may have an N₂ concentration in a range having a lower limit of any one of 15, 17, and 20 mol % and an upper limit of any of one of 22, 25, and 30 mol %, where any lower limit may be used in combination with any mathematically-compatible upper limit.

The claus tail gas flow control system of one or more embodiments may include several components including but not limited to a flow control device and a flow meter. The flow control device may be a choke valve, orifice, needle valve, or the like. A flow meter is connected to the flow control mechanism to measure a flow rate through the air line. The flow meter may be any flow meter known in the art capable of measuring a fluid flow rate. The flow meter of one or more embodiments may be an ultrasonic flow meter, a vortex flow meter, a magnetic flow meter, a turbine flow meter, a paddle wheel flow meter, and the like.

Keeping with FIG. 2A, the flash gas stream 216 and the vent gas stream may combine to produce a combined process gas stream 222. The combined process gas stream 222 may pass through a combined process gas line 217, where the combined process gas line 217 may include a process gas flow control system 220.

The flash gas stream of one or more embodiments may include primarily light hydrocarbons (C₁₋₄). The flash gas stream may include moderate amounts of other components, including but not limited to nitrogen (N₂) gas, water vapor, and carbon and dioxide (CO₂). The flash gas stream may also include minor amounts of other components, such as hydrogen sulfide (H₂S), benzene, toluene, p-xylene, helium, and other hydrocarbons.

In one or more embodiments, the flash gas stream may have a C₁₋₄ concentration that is a significant portion of the total composition of the flash gas stream. In one or more embodiments, the flash gas stream may be comprised of C₁₋₄ in a concentration having a range of from about 80 mol % to about 90 mol %. In one or more embodiments, the flash gas stream may have a C₁₋₄ concentration in a range having a lower limit of any one of 80, 82, and 84 mol %, and an upper limit of any of 86, 88, and 90 mol %, where any lower limit may be used in combination with any mathematically-compatible upper limit.

In one or more embodiments, the flash gas stream may be comprised of the N₂ in a concentration having a range of from about 5 mol % to about 20 mol %. In one or more embodiments, the fuel gas stream may have a N₂ concentration in a range having a lower limit of any one of 5, 7, and 10 mol %, and an upper limit of any of 12, 15, and 20 mol %, where any lower limit may be used in combination with any mathematically-compatible upper limit.

The vent gas stream of one or more embodiments may include acid gases, such as H₂S and CO₂.

In one or more embodiments, the vent gas stream may be comprised of the CO₂ in a concentration having a range of from about 85 mol % to about 99 mol %. In one or more embodiments, the vent gas stream may have an CO₂ concentration in a range having a lower limit of any one of 85, 87, and 90 mol % and an upper limit of any of one of 92, 95, 97, and 99 mol %, where any lower limit may be used in combination with any mathematically-compatible upper limit.

In one or more embodiments, the vent gas stream may be comprised of the H₂S in a concentration having a range of from about 100 ppm to about 3000 ppm. In one or more embodiments, the vent gas stream may have an H₂S concentration in a range having a lower limit of any one of 100, 250, and 500 ppm, and an upper limit of any of 750, 1000, 2000, and 3000 ppm, where any lower limit may be used in combination with any mathematically-compatible upper limit.

The vent gas stream may originate from one or more processes in a gas treatment plant, including but not limited to an acid gas enrichment (AGE) system.

The combined process gas stream of one or more embodiments may include any of the components found in the flash gas stream and the vent gas stream from which it originates.

The process gas flow control system of one or more embodiments may include several components including but not limited to a flow control device and a flow meter. The flow control device may be a choke valve, orifice, needle valve, or the like. A flow meter is connected to the flow control mechanism to measure a flow rate through the combined process gas line. The flow meter may be any flow meter known in the art capable of measuring a fluid flow rate. The flow meter of one or more embodiments may be an ultrasonic flow meter, a vortex flow meter, a magnetic flow meter, a turbine flow meter, a paddle wheel flow meter, and the like.

The first system 200, as depicted in FIG. 2A, also includes an incinerator system 232, where the fuel inlet stream 212, the claus tail gas stream 156, and the combined process gas stream 222 enter the incinerator system 232 and a flue gas stream 236 exits the incinerator system 232. The incinerator system 232 may also include a temperature control system 234.

The incinerator system of one or more embodiments may be any incinerator system capable of combusting one or more gas streams. For example, the incinerator system may include a thermal oxidizer incinerator and a thermal oxidizer stack.

In one or more embodiments, more than one incinerator system may operate as part of the first system 200. For example, a series of multiple incinerators may be included in the first system 200, where each of the incinerators may receive at least a portion of each of the gas streams entering the incinerator system 232 as shown in FIG. 2A.

The flue gas stream of one or more embodiments may include primarily CO₂, N₂, and water vapor. The flue gas stream may include moderate amounts of O₂ and minor amounts of other components, including Ar, H₂, and H₂S and other sulfur containing compounds.

In one or more embodiments, the flue gas stream may be comprised of the N₂ in a concentration having a range of from about 45 mol % to about 70 mol %. In one or more embodiments, the flue gas stream may have a N₂ concentration in a range having a lower limit of any one of 45, 50, and 55 mol %, and an upper limit of any of 60, 65, and 70 mol %, where any lower limit may be used in combination with any mathematically-compatible upper limit.

In one or more embodiments, the flue gas stream may be comprised of the CO₂ in a concentration having a range of from about 15 mol % to about 30 mol %. In one or more embodiments, the flue gas stream may have a CO₂ concentration in a range having a lower limit of any one of 15, 17, and 20 mol %, and an upper limit of any of 22, 25, and 30 mol %, where any lower limit may be used in combination with any mathematically-compatible upper limit.

In one or more embodiments, the flue gas stream may be comprised of the H₂O in a concentration having a range of from about 5 mol % to about 15 mol %. In one or more embodiments, the flue gas stream may have a H₂O concentration in a range having a lower limit of any one of 5, 7, and 10 mol %, and an upper limit of any of 12 and 15 mol %, where any lower limit may be used in combination with any mathematically-compatible upper limit.

The temperature control system of one or more embodiments may be any temperature control system capable of adjusting and maintaining an incinerator temperature. The temperature control system 234 may include burner systems and gas mixers to ensure adequate gas mixing within the incinerator system 232.

Returning to FIG. 2A, the first system 200 may also include a Sulfur Recovery Unit (SRU) fuel optimizer 238. The SRU fuel optimizer 238 according to the first system 200 includes, at least, a first relationship 240. The SRU fuel optimizer 238 may be configured to receive a fuel flow rate from the fuel flow control system 204 disposed on the fuel gas line 203. The SRU fuel optimizer 238 may also be configured to receive an air flow rate from the air flow control system 210 disposed on the air line 209. The SRU fuel optimizer 238 may also be configured to receive a claus tail gas flow rate from the claus tail gas flow control system 211 disposed on the claus tail gas line 215. The SRU fuel optimizer 238 may also be configured to receive a process gas flow rate from the process gas flow control system 220 disposed on the combined process gas line 217. The SRU fuel optimizer 238 may also be configured to receive a temperature of the incinerator system 232 from the temperature control system 234 disposed on the incinerator system 232. Data acquisition is depicted by dashed lines in FIG. 2A.

The SRU fuel optimizer of one or more embodiments is a set of control logic for maintaining optimum incineration operations at minimum fuel gas supply, both for TGTU online and TGTU offline operations. The “brain” for this logic is a set of correlations extracted from a simulation program (such as PROMAX) for maintaining the optimum incineration operations at various incinerator feed conditions. The SRU optimizer uses data from actual flowmeters, for example, as part of the system described in FIG. 2A above, in the extracted correlation. An optimizer logic will automatically calculate and provide the optimum incinerator temperature set point based on the acquired flowrate data. Therefore, the incinerator can be automatically maintained at optimum operation (minimum fuel gas usage) with less human intervention. Methods for developing and using automatic logic as described will be discussed in further detail in the following sections.

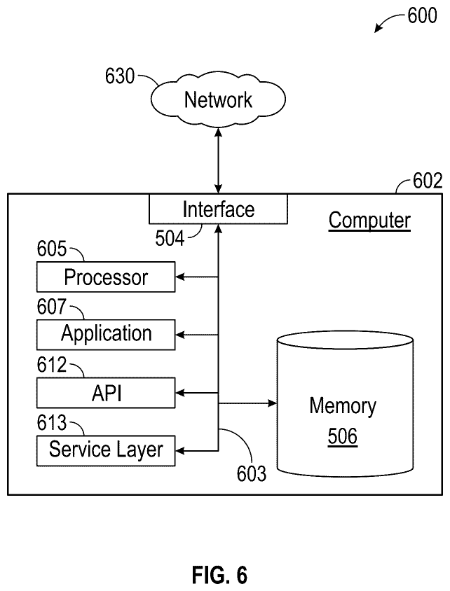

Keeping with FIG. 2A, in one or more embodiments, the SRU fuel optimizer 238 may select the first relationship 240 when a determination is made that a tail gas treatment unit (TGTU) is offline or otherwise not included or a part of the first system 200. In one or more embodiments, a TGTU may be determined to be offline if a TGTU offgas flow rate is measured to be zero. In one or more embodiments, after the determination is made that the tail gas treatment unit is offline or otherwise unavailable and the first relationship 240 is selected, the SRU fuel optimizer 238 determines, based on the first relationship 240, an optimal operating temperature of the incinerator system 232. The first relationship is shown in FIG. 7 and will be discussed in more detail in the Examples section, below.

The system of FIG. 2A also includes a controller 242. The controller 242 receives input data from the SRU fuel optimizer 238. In one or more embodiments, the controller 242 may provide instructions to adjust a temperature of the incinerator system 232 using the temperature control system 234. In one or more embodiments, the controller may provide instructions to adjust the temperature of the incinerator system 232 based on the optimal operating temperature determined by the SRU fuel optimizer 238.

In one or more embodiments, the controller may provide instructions to adjust a fuel flow rate using the fuel flow control system 204. In one or more embodiments, the controller may provide instructions to adjust the fuel flow rate based on the optimal operating temperature determined by the SRU fuel optimizer 238.

In one or more embodiments, the controller may provide instructions to adjust an air flow rate using the air flow control system 210. In one or more embodiments, the controller may provide instructions to adjust the air flow rate based on the optimal operating temperature determined by the SRU fuel optimizer 238. The flow rate data sent to the controller and the flow rate and temperature data sent from the controller are depicted by dashed lines in FIG. 2A.

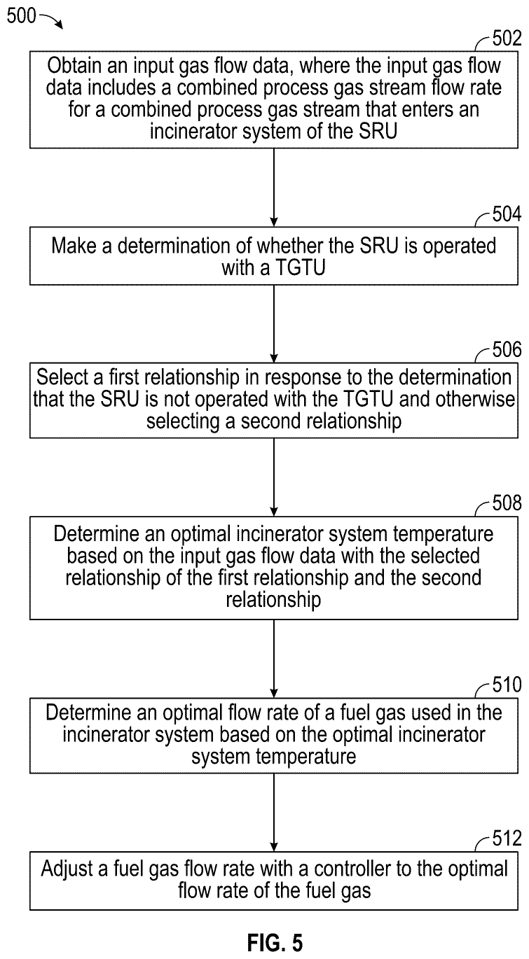

In one or more embodiments, the controller may be a computer such as the computer depicted in FIG. 6. The computer in FIG. 6 will be discussed in more detail, below.

FIG. 2B shows a second system 250 for implementing an SRU fuel optimizer 238 where a TGTU is online, according to one or more embodiments. The second system 250 may include similar elements to the first system 200 shown in FIG. 2A. For example, the second system 250 may include a fuel gas stream 202, an air stream 208, a flash gas stream 216, and a vent gas stream 224. The fuel gas stream 202 may flow through a fuel gas line 203, where the fuel gas line 203 includes a fuel flow control system 204.

In the second system 250 the air stream 208 may pass through an air line 209, where the air line 209 includes an air flow control system 210. The air stream 208 may combine with the fuel gas stream 202 to produce a fuel inlet stream 212. The flash gas stream 216 and the vent gas stream 224 may combine to produce a combined process gas stream 222. The combined process gas stream 222 may flow through a combined process gas line 217, where the combined process gas line 217 may include a process gas flow control system 220.

The second system 250, depicted in FIG. 2B, may also include a tail gas treatment unit (TGTU) offgas stream 244. The TGTU offgas stream 244 may flow through a TGTU offgas line 245.

The TGTU offgas stream may include primarily CO₂ and N₂. The TGTU offgas stream may also contain moderate amounts of H₂ and water vapor. The TGTU offgas stream may contain minor amounts of other components, such as Ar, H₂S, and other sulfur containing components.

In one or more embodiments, the TGTU offgas stream may be comprised of the CO₂ in a concentration having a range of from about 50 mol % to about 75 mol %. In one or more embodiments, the TGTU offgas stream may have a CO₂ concentration in a range having a lower limit of any one of 50, 55, and 60 mol % and an upper limit of any of one of 70 and 75 mol %, where any lower limit may be used in combination with any mathematically-compatible upper limit.

In one or more embodiments, the TGTU offgas stream may be comprised of the N₂ in a concentration having a range of from about 15 mol % to about 30 mol %. In one or more embodiments, the TGTU offgas stream may have an N₂ concentration in a range having a lower limit of any one of 15, 17, and 20 mol % and an upper limit of any of one of 22, 25, and 30 mol %, where any lower limit may be used in combination with any mathematically-compatible upper limit.

In the second system 250, the combined process gas stream 222, the fuel inlet stream 212, and the TGTU offgas stream 244 may enter the incinerator system 232. The combined process gas stream 222 flows through a combined process gas line 217, fluidly connected to the incinerator system 232. The fuel inlet stream 212 flows through a fuel inlet line 213, fluidly connected to the incinerator system 232. The TGTU offgas stream 244 flows through a TGTU offgas line 245, fluidly connected to the incinerator system 232. The TGTU offgas line 245 may include a TGTU offgas flow control system 246. The incinerator system 232 may also include a temperature control system 234. A second flue gas stream 254 exits the incinerator system 232 in the second system 250 of FIG. 2B.

In one or more embodiments, more than one incinerator system may operate as part of the system in FIG. 2B. For example, a series of multiple incinerators may be included in the second system 250, where each of the incinerators may receive at least a portion of the gas stream which enters the incinerator system as shown in FIG. 2B.

The second flue gas stream of one or more embodiments may include primarily CO₂ N₂, and water vapor. The second flue gas stream may include moderate amounts of O₂ and minor amounts of other components, including Ar, H₂, and H₂S and other sulfur containing compounds.

In one or more embodiments, the second flue gas stream may be comprised of the N₂ in a concentration having a range of from about 45 mol % to about 70 mol %. In one or more embodiments, the second flue gas stream may have a N₂ concentration in a range having a lower limit of any one of 45, 50, and 55 mol %, and an upper limit of any of 60, 65, and 70 mol %, where any lower limit may be used in combination with any mathematically-compatible upper limit.

In one or more embodiments, the second flue gas stream may be comprised of the CO₂ in a concentration having a range of from about 15 mol % to about 30 mol %. In one or more embodiments, the second flue gas stream may have a CO₂ concentration in a range having a lower limit of any one of 15, 17, and 20 mol %, and an upper limit of any of 22, 25, and 30 mol %, where any lower limit may be used in combination with any mathematically-compatible upper limit.

In one or more embodiments, the second flue gas stream may be comprised of the H₂O in a concentration having a range of from about 5 mol % to about 15 mol %. In one or more embodiments, the second flue gas stream may have a H₂O concentration in a range having a lower limit of any one of 5, 7, and 10 mol %, and an upper limit of any of 12 and 15 mol %, where any lower limit may be used in combination with any mathematically-compatible upper limit.

The TGTU offgas flow control system of one or more embodiments may include several components including but not limited to a flow control device and a flow meter. The flow control device may be a choke valve, orifice, needle valve, or the like. A flow meter is connected to the flow control mechanism to measure a flow rate through the TGTU offgas line. The flow meter may be any flow meter known in the art capable of measuring a fluid flow rate. The flow meter of one or more embodiments may be an ultrasonic flow meter, a vortex flow meter, a magnetic flow meter, a turbine flow meter, a paddle wheel flow meter, and the like.

Returning to FIG. 2B, the second system 250 may also include a Sulfur Recovery Unit (SRU) fuel optimizer 238. The SRU fuel optimizer 238 according to the second system 250 includes, at least, a second relationship 252. The SRU fuel optimizer 238 may be configured to receive a fuel flow rate from the fuel flow control system 204 disposed on the fuel gas line 203. The SRU fuel optimizer 238 may also be configured to receive an air flow rate from the air flow control system 210 disposed on the air line 209. The SRU fuel optimizer 238 may also be configured to receive a process gas flow rate from the process gas flow control system 220 disposed on the combined process gas line 217. The SRU fuel optimizer 238 may also be configured to receive a TGTU offgas flow rate from the TGTU offgas flow control system 246 disposed on the TGTU offgas line 245. The SRU fuel optimizer 238 may also be configured to receive a temperature of the incinerator system 232 from the temperature control system 234 disposed on the incinerator system 232. The flow rate data acquisition is depicted by dashed lines in FIG. 2B.

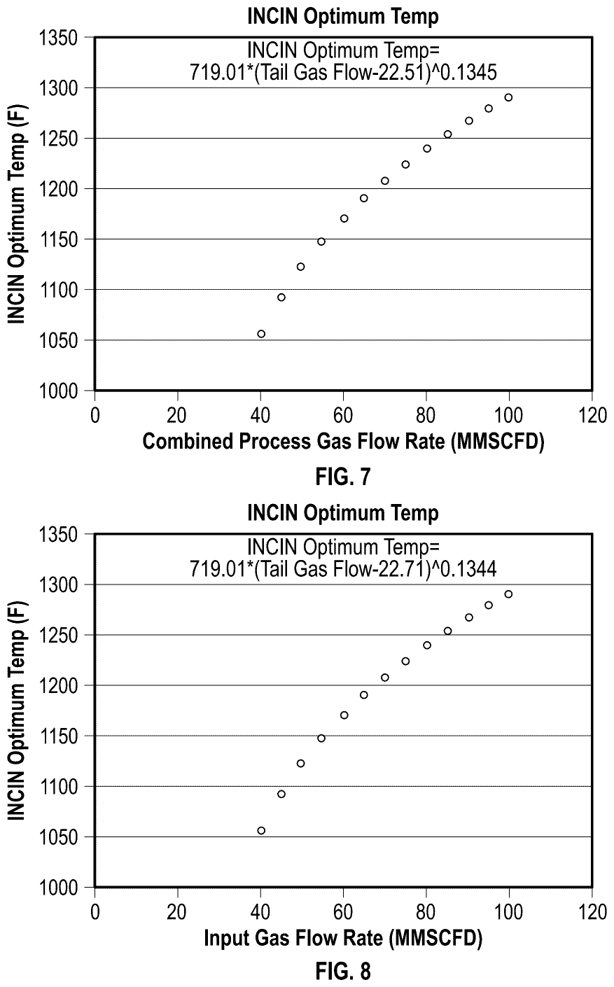

Returning to FIG. 2B, in one or more embodiments, the SRU fuel optimizer 238 may select the second relationship 252 when a determination is made that a tail gas treatment unit is online. In one or more embodiments, a TGTU may be determined to be online if a TGTU offgas flow rate is measured to be non-zero. In one or more embodiments, after the determination is made that the tail gas treatment unit is online and the second relationship 252 is selected, the SRU fuel optimizer 238 determines, based on the second relationship 252, an optimal operating temperature of the incinerator system 232. The second relationship is shown in FIG. 8 and will be discussed in more detail in the Examples section, below.

The system of FIG. 2B also includes a controller 242. The controller 242 receives input data from the SRU fuel optimizer 238. In one or more embodiments, the controller 242 may provide instructions to adjust a temperature of the incinerator system 232 using the temperature control system 234. In one or more embodiments, the controller may provide instructions to adjust the temperature of the incinerator system 232 based on the optimal operating temperature determined by the SRU fuel optimizer 238.

In one or more embodiments, the controller may provide instructions to adjust a fuel flow rate using the fuel flow control system 204. In one or more embodiments, the controller may provide instructions to adjust the fuel flow rate based on the optimal operating temperature determined by the SRU fuel optimizer 238.

In one or more embodiments, the controller may provide instructions to adjust an air flow rate using the air flow control system 210. In one or more embodiments, the controller may provide instructions to adjust the air flow rate based on the optimal operating temperature determined by the SRU fuel optimizer 238.

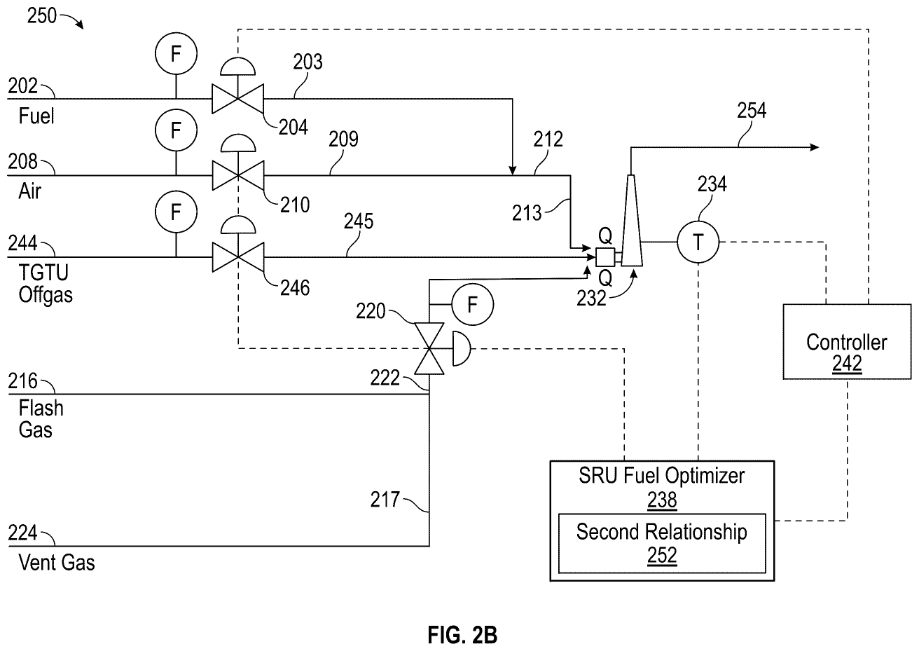

FIG. 3 illustrates a flow chart of a method 300 according to one or more embodiments. In step 305, a process gas flow rate is obtained from a process flow control system. In some instances, a mixed TGTU offgas flow rate is obtained and combined with the process gas flow rate to obtain an input gas flow rate.

The method 300 also includes, in step 310, making a determination as to whether an SRU is configured with a TGTU and, if so, whether the TGTU is operational. In one or more embodiments, the determination of whether a TGTU is operational may be based on the flow rate of a TGTU offgas stream. In instances where a TGTU is not provided (e.g., in the first system 200) the obtained TGTU offgas stream flow rate is necessarily zero and in instances where the TGTU is determined to be present and operational (e.g., in the second system 250), the obtained TGTU offgas stream flow rate is non-zero. If the TGTU is determined not to be operational (or the SRU is not configured with a TGTU), the flow chart of FIG. 3 proceeds to step 315.

In step 315, the method 300 also includes using a first relationship to determine an optimal incinerator temperature. The first relationship, as described in greater detail later in the instant disclosure, relates an optimal incinerator operating temperature based on the flow rate of a combined process gas, in addition to a flow rate of the claus tail gas in view of the TGTU being non-operational (or not being present within the system). Otherwise, in step 310, if the TGTU is determined to be operational, the flow chart of FIG. 3 proceeds to step 320. In step 320, a second relationship is used to determine an optimal incinerator temperature. The second relationship will also be described in more detail in the sections below. The second relationship relates an optimal incinerator operating temperature based on the flow rate of the combined process gas in addition to the flow rate of the mixed TGTU offgas in view of the TGTU being online.

In step 325, an optimal flow rate of fuel gas to the incinerator of the SRU is determined based on the optimal incinerator temperature depending on if the first relationship was selected in step 315 or the second relationship was selected in step 320. Then, in step 330, the fuel gas flow rate is adjusted, using a controller, to the optimal flow rate of the fuel gas, as determined in step 325. The controller is in electrical communication with, at least, the flow control system disposed on the fuel gas line and an SRU fuel optimizer. The SRU fuel optimizer may select the first relationship or the second relationship as determined by the above steps. The SRU fuel optimizer may then send instructions to the controller to adjust the fuel gas flow rate accordingly.

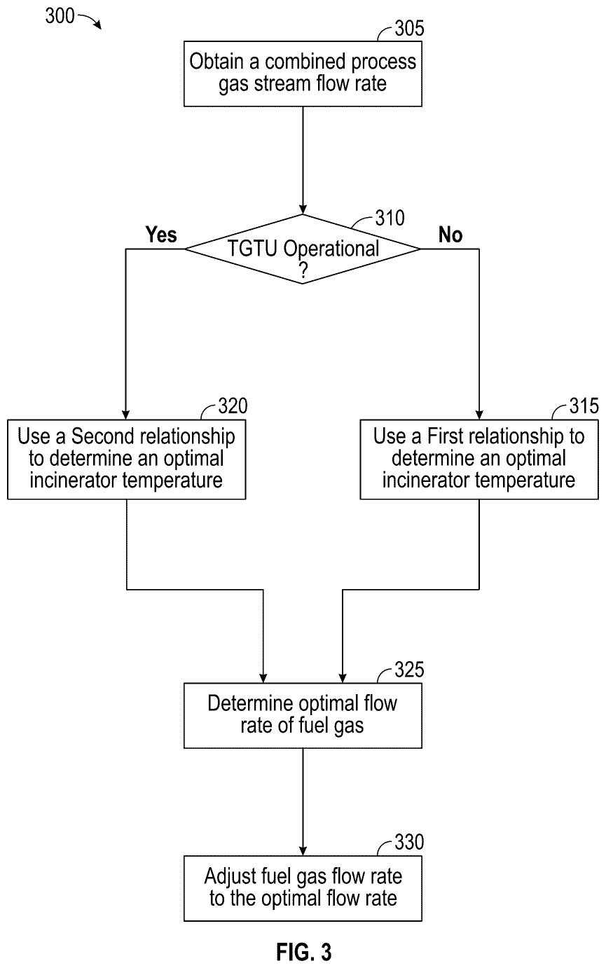

FIG. 4 illustrates a flow chart of a method for how the SRU fuel optimizer was developed 400 according to one or more embodiments. In step 405, process flowrates and compositions (i.e., data acquired from the combined process gas 222, the claus tail gas 156 or TGTU offgas 244, the air 208 and the fuel 202 streams in FIGS. 2A or 2B) were analyzed to accurately calculate the required temperature to burn the aforementioned gasses. Additionally, conditions of the model (TGTU online or TGTU offline) are identified and analyzed. In step 410, PROMAX software was used to simulate gas treatment operations using the data acquired in step 405.

PROMAX is a multifaceted process simulation software package that is made by engineers for engineers. It is designed to optimize gas processing, refining, and chemical facilities. PROMAX was developed by Bryan Research & Engineering, LLC (bre.com) and is considered an accurate simulation tool in gas processing and TGTU units.

Keeping with FIG. 4, in step 410 acquired operation parameters, such as flow, temperature, and pressure may be inserted into PROMAX. The PROMAX software then simulates an optimized model which may be used to operate the incinerator in terms of flow, temperature, and pressure. “Optimum operating conditions” according to one or more embodiments include an optimum (i.e., minimum) temperature and an optimum operating fuel rate (i.e., minimum). The optimum temperature is therefore the lowest possible incinerator operating temperature to ensure that there is full destruction of H₂S (at least 99.99% of H₂S is converted) into sulfur dioxide (SO₂) with no additional excess wasted energy of adding more fuel. Thus, the aim of the first relationship and the second relationship according to embodiments disclosed herein is to ensure the fuel consumption is as low as possible to avoid wasting cost and energy but also to ensure that fuel consumption is sufficient to have full destruction of H₂S, as defined above.

Keeping with FIG. 4, the simulation program in step 410 then accurately calculates how much energy (incinerator temperature) is required to convert the toxic gasses such as H₂S into less harmful components. Upon simulating an optimum process operation, the first relationship and the second relationship (i.e., FIGS. 7-8) according to one or more embodiments are obtained. In some embodiments, PROMAX software simulations may be replaced with ASPEN PLUS, HYSYS, or hand calculations.

In step 415, the empirical correlations may then be fed to the intelligent control block distributed control system logic (DCS logic) in the facility (DCS control room). The “intelligent control block” uses an “if” statement to operate the two cases (TGTU online or TGTU offline). The logic is operated automatically checking the status of the TGTU system to choose the correct relationship to operate the incinerator system. DCS is defined herein as “distributed control system” which is a computerized control system for the plant processes. The intelligent control block is installed into DCS system to operate the logic. After implementation, the logic will work automatically where the parameters will be adjusted automatically during plant operation.

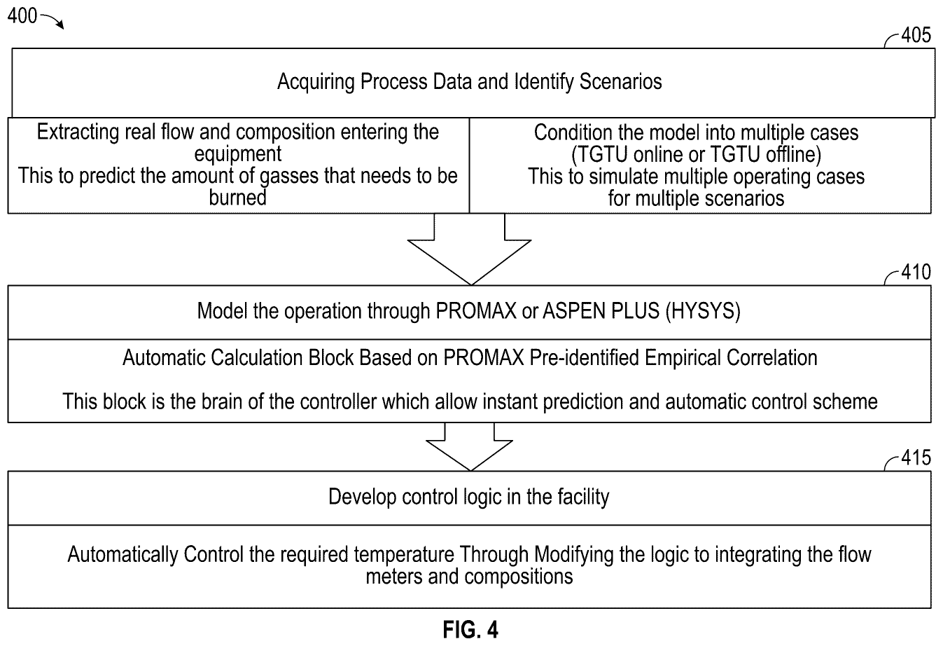

FIG. 5 shows a flow chart of a method 500 method for minimizing fuel consumption in an incinerator system in a sulfur recovery unit (SRU) in accordance with one or more embodiments disclosed herein. In step 502, an input gas flow data is obtained, where the input gas flow data includes a process gas stream flow rate for the combined process gas stream and a claus tail gas flow rate for a claus tail gas stream that enters an incinerator system.

The method 500 further includes, in step 504, making a determination of whether the SRU is operated with a TGTU. In some embodiments, making a determination of whether the SRU is operated with a TGTU includes determining whether a TGTU offgas stream flow rate is equal to zero, where the TGTU offgas stream flow rate is equal to zero when the SRU is not operated with the TGTU and where the TGTU offgas stream flow rate is not zero when the SRU is operated with the TGTU.

The method 500 also includes, in step 506, selecting a first relationship in response to the determination that the SRU is not operated with the TGTU and otherwise selecting a second relationship. In some embodiments, the first relationship is determined with a process simulator configured to simulate a process flow based on the input gas flow data when the tail gas treatment unit is not operational. In some embodiments, the second relationship is determined using a process simulator configured to simulate a process flow based on the input gas flow data when the tail gas treatment unit is operational.

In step 508, an optimal incinerator system temperature based on the input gas flow data is determined with the selected relationship of the first relationship and the second relationship.

In step 510, an optimal flow rate of a fuel gas used in the incinerator system is determined based on the optimal incinerator system temperature.

Finally, in step 512, a fuel gas flow rate is adjusted with a controller to the optimal flow rate of the fuel gas. In some embodiments, the controller is in electrical communication with a fuel flow control system disposed on a fuel gas line to control the fuel gas flow rate and a temperature control system in the incinerator system to control an incinerator system temperature. In some embodiments, the controller is further in communication with an air flow control system disposed on an air line to control an air stream flow rate. In some embodiments, the air stream flow rate is adjusted, with the controller, based on the optimal incinerator system temperature.

FIG. 6 shows a computer 600 system that may be used in the control process for adjusting a temperature to minimize fuel consumption in an incinerator system in accordance with one or more embodiments. Specifically, FIG. 6 shows a block diagram of a computer 600 system used to provide computational functionalities associated with described algorithms, methods, functions, processes, flows, and procedures as described in the instant disclosure, according to an implementation. The illustrated computer 600 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device.

Additionally, the computer 600 may include a computer that includes an input device, such as a keypad, keyboard, touch screen, or other device that can accept user information, and an output device that conveys information associated with the operation of the computer 600, including digital data, visual, or audio information (or a combination of information), or a GUI.

The computer 600 can serve in a role as a client, network component, a server, a database or other persistency, or any other component (or a combination of roles) of a computer system for performing the subject matter described in the instant disclosure. The illustrated computer 600 is communicably coupled with a network 602. In some implementations, one or more components of the computer 600 may be configured to operate within environments, including cloud-computing-based, local, global, or other environments (or a combination of environments).

At a high level, the computer 600 is an electronic computing device operable to receive, transmit, process, store, or manage data and information associated with the described subject matter. According to some implementations, the computer 600 may also include or be communicably coupled with an application server, e-mail server, web server, caching server, streaming data server, business intelligence (BI) server, or other server (or a combination of servers).

The computer 600 can receive requests over network 602 from a client application (for example, executing on another computer 600) and responding to the received requests by processing the said requests in an appropriate software application. In addition, requests may also be sent to the computer 600 from internal users (for example, from a command console or by other appropriate access method), external or third-parties, other automated applications, as well as any other appropriate entities, individuals, systems, or computers.

Each of the components of the computer 600 can communicate using a system bus 604. In some implementations, any or all of the components of the computer 600, both hardware or software (or a combination of hardware and software), may interface with each other or the interface 606 (or a combination of both) over the system bus 604 using an application programming interface (API) 608 or a service layer 610 (or a combination of the API 608 and service layer 610. The API 608 may include specifications for routines, data structures, and object classes. The API 608 may be either computer-language independent or dependent and refer to a complete interface, a single function, or even a set of APIs. The service layer 610 provides software services to the computer 600 or other components (whether or not illustrated) that are communicably coupled to the computer 600.

The functionality of the computer 600 may be accessible for all service consumers using this service layer 610. Software services, such as those provided by the service layer 610, provide reusable, defined business functionalities through a defined interface. For example, the interface may be software written in JAVA, C++, or other suitable language providing data in extensible markup language (XML) format or other suitable format. While illustrated as an integrated component of the computer 600, alternative implementations may illustrate the API 608 or the service layer 610 as stand-alone components in relation to other components of the computer 600 or other components (whether or not illustrated) that are communicably coupled to the computer 600. Moreover, any or all parts of the API 608 or the service layer 610 may be implemented as child or sub-modules of another software module, enterprise application, or hardware module without departing from the scope of this disclosure.

The computer 600 includes an interface 606. Although illustrated as a single interface 606 in FIG. 6, two or more interfaces 606 may be used according to particular needs, desires, or particular implementations of the computer 600. The interface 606 is used by the computer 600 for communicating with other systems in a distributed environment that are connected to the network 602. Generally, the interface 606 includes logic encoded in software or hardware (or a combination of software and hardware) and operable to communicate with the network 602. More specifically, the interface 606 may include software supporting one or more communication protocols associated with communications such that the network 602 or interface's hardware is operable to communicate physical signals within and outside of the illustrated computer 600.

The computer 600 includes at least one computer processor 612. Although illustrated as a single computer processor 612 in FIG. 6, two or more processors may be used according to particular needs, desires, or particular implementations of the computer 600. Generally, the computer processor 612 executes instructions and manipulates data to perform the operations of the computer 600 and any algorithms, methods, functions, processes, flows, and procedures as described in the instant disclosure.

The computer 600 also includes a non-transitory computer 600 readable medium, or a memory 614, that holds data for the computer 600 or other components (or a combination of both) that can be connected to the network 602. For example, memory 614 can be a database storing data consistent with this disclosure. Although illustrated as a single memory 614 in FIG. 6, two or more memories may be used according to particular needs, desires, or particular implementations of the computer 600 and the described functionality. While memory 614 is illustrated as an integral component of the computer 600, in alternative implementations, memory 614 can be external to the computer 600.

The application 616 is an algorithmic software engine providing functionality according to particular needs, desires, or particular implementations of the computer 600, particularly with respect to functionality described in this disclosure. For example, application 616 can serve as one or more components, modules, applications, etc. Further, although illustrated as a single application 616, the application 616 may be implemented as multiple applications 616 on the computer 600. In addition, although illustrated as integral to the computer 600, in alternative implementations, the application 616 can be external to the computer 600.

There may be any number of computers 600 associated with, or external to, a computer system containing computer 600, each computer 600 communicating over network 602. Further, the term “client,” “user,” and other appropriate terminology may be used interchangeably as appropriate without departing from the scope of this disclosure. Moreover, this disclosure contemplates that many users may use one computer 600, or that one user may use multiple computers 600.

Embodiments of the present disclosure may provide at least one of the following advantages. The automatic SRU fuel optimizer according to one or more embodiments may dynamically optimize the incinerator fuel gas usage by acknowledging a combined process gas flow rate and incinerator mode of operations (i.e., whether or not a tail gas treatment unit is present and online). By implementing this initiative, corresponding Operating Expenditure (OPEX) can be saved in addition to emission reduction while maintaining SRU operation.

Embodiments disclosed herein may advantageously use variable temperature control optimized through real modeling. Conventional operations may use a fixed temperature while operating incinerators. In addition, conventional operations may be operated manually, whereas methods and systems according to embodiments disclosed herein may be automatically controlled to ensure optimized operations.

### EXAMPLES

A gas plant can operate one or more incinerators, or thermal oxidizers, which are significant consumers of fuel gas, accounting for a major portion of the plant's fuel usage. Systems and methods according to one or more embodiments minimize the fuel gas consumption by calculating a precise amount of fuel gas required to convert H₂S into SO₂. Sulphur Recovery Unit (SRU) incinerators are often used in natural gas processing operations to convert toxic H₂S into SO₂. Unlike traditional methods that operate with a constant fuel gas consumption regardless of the acid feed gas, methods according to one or more embodiments may dynamically adjust a fuel gas consumption based on real-time requirements, leading to substantial fuel savings.

In addition to the primary SRU incineration process, a gas plant can incorporate a Tail Gas Treatment process. In one or more embodiments, a gas plant operates according to two distinct operational modes. The first mode addresses the operation of the SRU without inclusion of a Tail Gas Treatment Unit (TGTU), while the second accommodates the integration of the SRU with a TGTU. Regardless of whether the plant operates with or without the TGTU, methods according to embodiments disclosed herein may provide significant fuel gas savings across both scenarios. Applicable to all gas plants equipped with SRU incinerators, embodiments disclosed herein not only optimize fuel gas consumption but may also eliminate the need for constant fuel gas usage, irrespective of train load. The implementation of automatic logic (i.e., at least the determination of whether a TGTU is operational and the determination of an optimal SRU incinerator temperature based on an incinerator input stream in view of the availability and operation of a TGTU) according to methods disclosed herein may allow the incinerator to autonomously reduce fuel gas usage in response to decreases in combined process gas and mixed TGTU offgas (if present) flow rates, thereby minimizing human intervention and enhancing operation efficiency.

The SRU fuel optimizer according to embodiments disclosed herein was developed by comprehensive technical assessment assisted by PROMAX simulation software. The automatic SRU fuel optimizer may dynamically optimize the incinerator fuel gas usage by acknowledging combined process gas amount and incinerator mode of operations. As an example, Operating Expenditure (OPEX) savings resulting from the application of the SRU fuel optimizer as described herein, applied to the Fadhili gas plant (with six identical incinerators) are approximated to be 360 M USD/Train, annually (the actual annual savings in FGP is around 102,000 USD/Train). Moreover, with refence to the Fadhili gas plant, an actual emission reduction up to 80 metric ton/Train can be obtained while maintaining excellent SRU operation.

In accordance with one or more embodiments, a process simulator (e.g., PROMAX) was employed to evaluate the optimum operating temperature based on the amount of input gas entering an incinerator of an SRU, both with and without the operation of a TGTU, to determine the first and second relationships. FIG. 7 illustrates the empirical correlation that relates an amount of combined process gas entering the incinerator to an optimal incinerator operating temperature developed using the process simulator when the TGTU is offline or otherwise non-operational or unavailable (e.g., the first system 200, configured without a TGTU). That is, FIG. 7 is a graphical depiction of the first relationship 240, in accordance with one or more embodiments. In FIG. 7, an optimum incinerator temperature is plotted versus a combined process gas flow rate, where the tail gas does not include TGTU offgas because the TGTU is offline. The “combined process gas flow rate” in FIG. 7 may originate from a combination of a process gas stream and a claus tail gas stream according to one or more embodiments, for example, stream 222 and 156 of FIG. 2A.

PROMAX process simulator was also employed to evaluate the optimum fuel gas demand based on the amount of input gas entering the incinerator when the TGTU is online. FIG. 8 illustrates the empirical correlation developed using PROMAX when the TGTU is online. In FIG. 8, an optimum incinerator temperature is plotted versus an input gas flow rate, where the input gas does include TGTU offgas because the TGTU is online. The “input gas flow rate” in FIG. 8 may originate from the combined flow rates of the combined process gas stream and the TGTU offgas stream according to one or more embodiments, for example, a combination of streams 222 and 244 in FIG. 2B.

The obtained empirical correlation of FIG. 7 or FIG. 8 may then be patched to the SRU temperature control system to dynamically control the incinerator temperature to its optimum point.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for minimizing fuel consumption in an incinerator system in a sulfur recovery unit (SRU), comprising:
obtaining input gas flow data comprising a process gas stream flow rate for a combined process gas stream and a claus tail gas flow rate for a claus tail gas stream that enter the incinerator system of the SRU;
making a determination of whether the SRU is operated with a tail gas treatment unit (TGTU);
selecting a first relationship in response to the determination that the SRU is not operated with the TGTU and otherwise selecting a second relationship;
determining, with the selected relationship of the first relationship and the second relationship, an optimal incinerator system temperature based on the input gas flow data;
determining, based on the optimal incinerator system temperature, an optimal flow rate of a fuel gas used in the incinerator system; and
adjusting, with a controller, a fuel gas flow rate to the optimal flow rate of the fuel gas.

2. The method of claim 1, wherein the controller is in electrical communication with:
a fuel flow control system disposed on a fuel gas line to control the fuel gas flow rate; and
a temperature control system in the incinerator system to control an incinerator system temperature.

3. The method of claim 1, further comprising: determining the first relationship with a process simulator configured to simulate a process flow based on the input gas flow data when the TGTU is not operational.

4. The method of claim 1, further comprising: determining the second relationship using a process simulator configured to simulate a process flow based on the input gas flow data when the TGTU is operational.

5. The method of claim 2, wherein the controller is in further electrical communication with: an air flow control system disposed on an air line to control an air stream flow rate.

6. The method of claim 5, further comprising adjusting, with the controller, the air stream flow rate based on the optimal incinerator system temperature.

7. The method of claim 1:
wherein the SRU is operated with the TGTU,
the method further comprising obtaining a TGTU offgas flow rate,
wherein a TGTU offgas flow control system disposed on a TGTU offgas line is configured to measure the TGTU offgas flow rate, and
wherein a TGTU offgas flows through the TGTU offgas line which enters the incinerator system.

8. A system for minimizing fuel consumption in an incinerator system in a sulfur recovery unit (SRU), comprising:
the incinerator system comprising a temperature control system;
wherein, at least, a fuel gas, a claus tail gas, and a combined process gas enter the incinerator system;
a claus tail gas line comprising a claus tail gas flow control system configured to measure a claus tail gas stream flow rate, wherein the claus tail gas flows through the claus tail gas line;
a combined process gas line comprising a process gas flow control system configured to measure a process gas stream flow rate, wherein the combined process gas flows through the combined process gas line;
a fuel gas line comprising a fuel flow control system configured to measure a fuel gas flow rate, wherein the fuel gas flows through the fuel gas line; and
a controller, communicably coupled to:
the fuel flow control system disposed on the fuel gas line to control the fuel gas flow rate, and
the temperature control system in the incinerator system to control an incinerator system temperature,
wherein the controller is configured to:
obtain input gas flow data comprising the process gas stream flow rate and the claus tail gas stream flow rate;
make a determination of whether the SRU is operated with a tail gas treatment unit (TGTU),
select a first relationship in response to the determination that the SRU is not operated with the TGTU and otherwise selecting a second relationship,
determine, with the selected relationship of the first relationship and the second relationship, an optimal incinerator system temperature based on the input gas flow data,
determine, based on the optimal incinerator system temperature, an optimal flow rate of the fuel gas, and
adjust, with the controller, the fuel gas flow rate to the optimal flow rate of the fuel gas.

9. The system of claim 8, wherein the SRU is operated with the TGTU and the input gas flow data further comprises a TGTU offgas flow rate, wherein:
the controller is further configured to obtain the TGTU offgas flow rate,
wherein a TGTU offgas flow control system disposed on a TGTU offgas line is configured to measure the TGTU offgas flow rate, and
wherein a TGTU offgas flows through the TGTU offgas line which enters the incinerator system.

10. The system of claim 8, further comprising a flue gas stream exiting the incinerator system.

11. The system of claim 9, further comprising an air stream line comprising an air flow control system configured to measure an air stream flow rate, wherein an air stream flows through the air stream line.

12. The system of claim 11, wherein the controller is further configured to:
receive the air stream flow rate; and
adjust, with the controller, the air stream flow rate based on the optimal incinerator system temperature.

13. The system of claim 11, wherein the air stream line is fluidly connected to a fuel inlet line and the air stream combines with the fuel gas to produce a fuel inlet stream that enters the incinerator system via the fuel inlet line.

14. A non-transitory computer-readable memory comprising computer-executable instructions stored thereon that, when executed on a processor, cause the processor to perform steps comprising:
obtaining input gas flow data comprising a process gas stream flow rate for a combined process gas stream and a claus tail gas flow rate for a claus tail gas stream that enter an incinerator system of a sulfur recovery unit (SRU);
making a determination of whether the SRU is operated with a tail gas treatment unit (TGTU);
selecting a first relationship in response to the determination that the SRU is not operated with the TGTU and otherwise selecting a second relationship;
determining, with the selected relationship of the first relationship and the second relationship, an optimal incinerator system temperature based on the input gas flow data;
determining, based on the optimal incinerator system temperature, an optimal flow rate of a fuel gas used in the incinerator system; and
adjusting a fuel gas flow rate to the optimal flow rate of the fuel gas.

15. The non-transitory computer-readable memory of claim 14, further comprising the steps:
obtaining and air stream flow rate for an air stream, wherein the air stream enters the incinerator system; and
adjusting the air stream flow rate based on the optimal incinerator system temperature.

16. The non-transitory computer-readable memory of claim 15, wherein the air stream flow rate is obtained using an air flow control system coupled to an air stream line, wherein the air stream flows through the air stream line.

17. The non-transitory computer-readable memory of claim 16, wherein the air stream line is fluidly connected to a fuel inlet line and the air stream combines with the fuel gas to produce a fuel inlet stream that enters the incinerator system.

18. The non-transitory computer-readable memory of claim 14:
wherein the SRU is operated with the TGTU and the input gas flow data further comprises a TGTU offgas flow rate, the steps further comprise:
obtaining the TGTU offgas flow rate, wherein a TGTU offgas flow control system disposed on a TGTU offgas line is configured to measure a TGTU offgas stream flow rate, and wherein a TGTU offgas flows through the TGTU offgas line which enters the incinerator system.

19. The non-transitory computer-readable memory of claim 14, the steps further comprising: determining the first relationship with a process simulator configured to simulate a process flow based on the input gas flow data when the TGTU is not operational.

20. The non-transitory computer-readable memory of claim 14, the steps further comprising: determining the second relationship using a process simulator configured to simulate a process flow based on the input gas flow data when the TGTU is operational.
